(19) United States
(12) Patent Application Publication
(10) Pub. No.: US 2025/0065228 A1
(43) Pub. Date: Feb. 27, 2025

(54) METHOD AND APPARATUS, ELECTRONIC DEVICE, MEDIUM AND PRODUCT FOR ANALYZING CLOUD GAME EXPERIENCE QUALITY

(71) Applicant: Beijing Zitiao Network Technology Co., Ltd., Beijing (CN)

(72) Inventors: Yanyan SUO, Beijing (CN); Yongqiang GUI, Beijing (CN); Shu SHI, Los Angeles, CA (US); Bin XU, Beijing (CN)

(21) Appl. No.: 18/798,476

(22) Filed: Aug. 8, 2024

(30) Foreign Application Priority Data
Aug. 23, 2023 (CN) 202311071319.9

(51) Int. Cl. A63F 13/35

(52) U.S. Cl. CPC A63F 13/35

(57) ABSTRACT

Embodiments of the disclosure disclose a method, an apparatus, an electronic device, a storage medium and a product for analyzing cloud game experience quality. The method includes: obtaining predetermined feature data associated with a cloud game experience quality during historical cloud game sessions; grouping the predetermined feature data corresponding to each of the historical cloud game sessions according to a predetermined segment duration, and determining a plurality of cloud game clip experience quality analysis results corresponding to each of the historical cloud game sessions based on each group of the feature data; and determining a corresponding target cloud game experience quality analysis result of each of the historical cloud game sessions respectively, based on the cloud game clip experience quality analysis results.

### CROSS-REFERENCE

The present application claims priority to Chinese Patent Application No. 202311071319.9, filed on Aug. 23, 2023 and entitled “METHOD AND APPARATUS, ELECTRONIC DEVICE, MEDIUM AND PRODUCT FOR ANALYZING CLOUD GAME EXPERIENCE QUALITY”, the entirety of which is incorporated herein by reference.

### FIELD

Embodiments of the present disclosure relates to the technical field of computers, in particular to a method, an apparatus, an electronic device, a medium and a product for analyzing cloud game experience quality.

### BACKGROUND

A cloud game is a game that implements a game calculation and rendering process in a cloud, and has features of cloud rendering and strong interactions. A user experience quality analysis of evaluating the cloud game can provide valuable reference information with game providers, so that cloud game resource configuration and technical optimization can be more effectively carried out, and the user experience of the cloud game is improved.

### SUMMARY

The present disclosure provides a method, an apparatus, an electronic device, a medium and a product for analyzing cloud game experience quality, which can overcome the factors of inaccurate analysis results in the unimproved cloud game experience quality analysis method, more accurately analyze the actual experience of a user in a cloud game, provide an accurate cloud game experience quality result, so as to more efficiently guide a scheme for cloud game resource configuration and technical optimization.

In a first aspect, an embodiment of the present disclosure provides a method for analyzing cloud game experience quality, comprising:
obtaining predetermined feature data associated with a cloud game experience quality during historical cloud game sessions;
grouping the predetermined feature data corresponding to each of the historical cloud game sessions according to a predetermined segment duration, and determining a plurality of cloud game clip experience quality analysis results corresponding to each of the historical cloud game sessions based on each group of the feature data; and
determining a corresponding target cloud game experience quality analysis result of each of the historical cloud game sessions respectively, based on the cloud game clip experience quality analysis results.

In a second aspect, an embodiment of the present disclosure further provides An apparatus for analyzing cloud game experience quality, comprising:
an experience quality analysis data obtaining module configured to obtain predetermined feature data associated with a cloud game experience quality during historical cloud game sessions;
an experience quality segmentation analysis module configured to group the predetermined feature data corresponding to each of the historical cloud game sessions according to a predetermined segment duration, and determine a plurality of cloud game clip experience quality analysis results corresponding to each of the historical cloud game sessions based on each group of the feature data; and
an experience quality comprehensive analysis module configured to determine a corresponding target cloud game experience quality analysis result of each of the historical cloud game sessions respectively, based on the cloud game clip experience quality analysis results.

In a third aspect, an embodiment of the present disclosure further provides an electronic device, comprising:
one or more processors; and
a storage apparatus for storing one or more programs,
wherein the one or more programs, when executed by the one or more processors, cause the one or more processors to implement the method for analyzing cloud game experience quality according to any of the embodiments of the present disclosure.

In a fourth aspect, an embodiment of the present disclosure further provides a storage medium comprising computer executable instructions which, when executed by a computer processor, perform the method for analyzing cloud game experience quality according to any of the embodiments of the present disclosure.

In a fifth aspect, an embodiment of the present disclosure further provides a computer program product comprising a computer program which, when executed by a processor, implements the method for analyzing cloud game experience quality according to any of the embodiments of the present disclosure.

According to the embodiments of the present disclosure, the predetermined feature data associated with the cloud game experience quality during the historical cloud game sessions is obtained; the predetermined feature data corresponding to each of the historical cloud game sessions is grouped according to the predetermined segment duration, and the plurality of cloud game clip experience quality analysis results corresponding to each of the historical cloud game sessions are determined based on each group of the feature data; and the corresponding target cloud game experience quality analysis results of each of the historical cloud game sessions are determined respectively based on the cloud game clip experience quality analysis results. That is, after each historical cloud game session is segmented, the experience quality analysis is performed in units of cloud game session clips, so that the influence of the feature data influencing the experience quality in any cloud game session clip on the experience quality of other cloud game session clips is reduced, and the accuracy of a final target cloud game experience quality analysis result of each historical cloud game session is improved. According to the scheme of the embodiments of the present disclosure, the technical problem of poor application effect of the existing cloud game experience quality analysis model is solved, the actual experience of the user in the cloud game can be more accurately analyzed, accurate cloud game experience quality results are provided, so as to more efficiently guide a scheme for cloud game resource configuration and technical optimization.

### BRIEF DESCRIPTION OF THE DRAWINGS

The above and other features, advantages, and aspects of the embodiments of the present disclosure will become more apparent from the following detailed description taken in conjunction with the accompanying drawings. Throughout the drawings, the same or similar reference numerals refer to the same or similar elements. It should be understood that the drawings are schematical, and components and elements are not necessarily drawn to scale.

FIG. 1 is a schematic flowchart of a method for analyzing cloud game experience quality according to an embodiment of the present disclosure;

FIG. 2 is a schematic diagram of a process of processing predetermined feature data packets according to an embodiment of the present disclosure;

FIG. 3 is a schematic flowchart of a cloud game experience quality analysis method according to an embodiment of the present disclosure;

FIG. 4 is a schematic flowchart of a method for analyzing cloud game experience quality according to an embodiment of the present disclosure;

FIG. 5 is a schematic diagram of a relationship between an experience quality analytical score of each cloud game session and the number of cloud game sessions with corresponding different durations according to an embodiment of the present disclosure;

FIG. 6 is a schematic diagram of a relationship between an experience quality analytical score of each cloud game session and changes in the number of corresponding long cloud game sessions according to an embodiment of the present disclosure;

FIG. 7 is a schematic diagram of a relationship between an experience quality analytical score of each cloud game session and changes in the number of corresponding short cloud game sessions according to an embodiment of the present disclosure;

FIG. 8 is a schematic diagram of a structure of an apparatus for analyzing cloud game experience quality according to an embodiment of the present disclosure; and

FIG. 9 is a schematic diagram of a structure of an electronic device according to an embodiment of the present disclosure.

### DETAILED DESCRIPTION

The embodiments of the present disclosure will be described in more detail below with reference to the accompanying drawings. While certain embodiments of the present disclosure are shown in the drawings, it is to be understood that the present disclosure may be embodied in various forms, and should not be construed as limited to the embodiments set forth herein; rather, these embodiments are provided so that this disclosure will be thorough and complete. It should be understood that the drawings and embodiments of the present disclosure are for exemplary purposes only, and are not intended to limit the scope of the present disclosure.

It should be understood that the steps recited in the method implementations of the present disclosure may be performed in different orders, and/or in parallel. Further, the method implementations may include additional steps and/or omit performing the illustrated steps. The scope of the present disclosure is not limited in this respect.

As used herein, the term “including” and variants thereof are open-ended, i.e., “including but not limited to”. The term “based on” is “based at least in part on”. The term “one embodiment” means “at least one embodiment”; the term “another embodiment” means “at least one further embodiment”; and the term “some embodiments” means “at least some embodiments”. Relevant definitions of other terms will be given below.

It should be noted that the terms such as “first” and “second” mentioned in the present disclosure are merely used to distinguish between different apparatuses, modules, or units, and are not intended to limit the order of functions performed by the apparatuses, modules, or units or the mutual dependency relationship.

It should be noted that the modification of “a”, “a plurality of” and the like mentioned in the present disclosure is illustrative and not limiting, and those skilled in the art should understand that this should be understood as “one or more,” unless the context clearly indicates otherwise.

It can be understood that, before the technical solutions disclosed in the embodiments of the present disclosure are used, the type, usage scope, usage scenario and the like of personal information related to the present disclosure should be notified to a user in an appropriate manner according to the relevant laws and regulations and authorized by the user.

For example, in response to receiving an active request from a user, prompt information is sent to the user to explicitly prompt the user that the requested operation will need to obtain and use the personal information of the user. Therefore, the user can autonomously select whether to provide the personal information to a software or hardware such as an electronic device, an application program, a server or a storage medium executing the operations of the technical solutions of the present disclosure, according to the prompt information.

As an optional but non-limiting implementation, in response to receiving the active request from the user, the manner of sending the prompt information to the user may be, for example, a pop-up window, and the prompt information may be presented in a text manner in the pop-up window. In addition, the pop-up window may further carry a select control for the user to select “agree” or “disagree” to provide the personal information to the electronic device.

It can be understood that the foregoing process of notifying and obtaining the user's authorization is merely illustrative, and does not constitute a limitation on implementations of the present disclosure, and other manners of meeting the relevant laws and regulations may also be applied to the implementations of the present disclosure.

It can be understood that data involved in the technical solution (including but not limited to the data itself, the obtaining or use of the data) should follow the requirements of corresponding laws and regulations and related provisions.

At present, an experience quality analysis of cloud game users mostly uses a Mean Opinion Score-Quality of Experience (MOS-QoE) model established based on an international general evaluation standard to obtain a MOS-QoE scoring result. The MOS-QoE scoring result is closely related to conditions such as pictures, lags, and latencies of a game.

However, a correlation between the MOS-QoE scoring result and the user's real experience is not sufficiently verified. In the practice of cloud game experience quality analysis, it is found that a relationship between the MOS-QoE scoring result and a game running duration does not conform to a logic relationship where the longer the game running duration is, the higher the MOS-QoE score is. Therefore, the accuracy of evaluation result of the MOS-QoE model is not high, and the evaluation result has low guiding significance on cloud game resource configuration and technical optimization of the cloud.

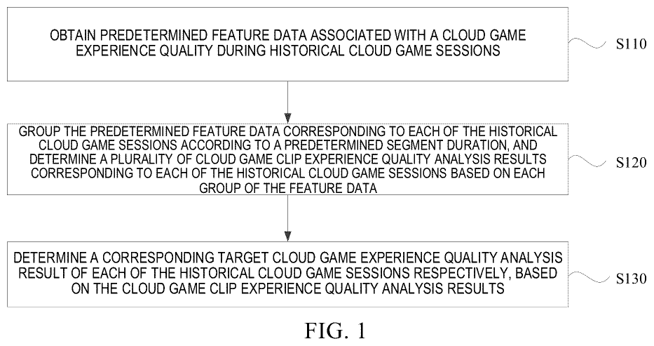

FIG. 1 is a schematic flowchart of a method for analyzing cloud game experience quality according to an embodiment of the present disclosure. The embodiment of the present disclosure is applicable to a scenario of evaluating experience quality of cloud game users, where the method may be performed by a cloud game experience quality analysis apparatus, which may be implemented in the form of software and/or hardware, and optionally, implemented by an electronic device, which may be a mobile terminal, a personal computer (PC), or a server, and the like.

It should be noted that, in the embodiment of the present disclosure, when the user experience index cannot be more accurately reflected, it is assumed that a game duration can effectively represent the game experience of the user, and a time of the game session is longer under the condition that the experience quality analysis result is better.

A cloud game is a form of emerging games, the appearance of which breaks the limitation of traditional game mode, and transfers the calculation and rendering capabilities of games from the local to the cloud, so that the user can directly obtain game resources and play the games through the Internet without downloading and installing the games themselves, thereby reducing the threshold of the user obtaining high-quality games. The evaluating the experience quality of cloud game users can provide more effective resource configuration and technical optimization schemes for game providers, and has important guiding significance for development of cloud game services. However, considering cloud rendering and strong interaction characteristics of the cloud game, this has a certain difficulty in the user experience quality analysis process.

At present, for this problem, the International Telecommunication Union Telecommunication Standardization Sector formulates a user experience quality evaluation standard for the cloud game services. Specifically, a picture resolution, a frame rate, a network delay and other information when a large number of users play the cloud games are collected first, and then subjective evaluation scores (1-5, where 1 represents the worst experience and 5 represents the best experience) of the user on the whole game experience are collected. Subsequently, a feature extraction is performed, and feature data related to the experience quality of the cloud game users is extracted from original data. These features may involve the network delay, the quality of video coding, the number of lags, and the like. Finally, the collected data is modeled by using a machine learning and data analysis technology, and a cloud game user experience quality evaluation model MOS-QoE is provided. The model can associate feature information in the game process with corresponding technical indexes and performance parameters, and obtain an evaluation score for evaluating the experience quality of the cloud game users. That is, the MOS-QoE experience quality evaluation model provides a common evaluation framework for the cloud game experience quality analysis, the scoring result is closely related to the conditions such as pictures, lags and latencies of the game, the key performance of the cloud games and the user experience can be evaluated and analyzed, and thus the quality and user experience improvement of the cloud game services are promoted.

However, in practical applications of the MOS-QoE experience quality evaluation model, the correlation between its scoring result and the user's real experience is not sufficiently verified. In order to explore a relationship between scores of the MOS-QoE experience quality evaluation model and the user experience, a cloud game system may obtain durations of historical cloud game sessions, and use the game duration as a method for verifying the scoring accuracy of the MOS-QoE experience quality evaluation model. However, the practice result not being conformed to the “the higher the scores of the MOS-QoE experience quality evaluation model are, the longer the game session time is” indicates that the MOS-QoE experience quality evaluation model cannot be directly used for the experience quality analysis of the cloud games, because there is a large uncertainty in the process, and the meaning of analysis result is not large. Therefore, a cloud game experience quality analysis method is provided in particular, and the cloud game experience quality of the user is accurately reflected under the condition that the logic relationship between the set “game duration” and the cloud game experience quality analysis result is met.

As shown in FIG. 1, the method for analyzing cloud game experience quality comprises:
at S110, obtaining predetermined feature data associated with a cloud game experience quality during historical cloud game sessions.

The cloud game session may be understood as a process in which any cloud game starts from game launching to game exiting. The historical cloud game session may be a process in which any cloud game starts from the game launching to the game exiting once any time recorded by the game providers in the cloud.

The predetermined feature data associated with the cloud game experience quality may be related feature data involved in the framework of the MOS-QoE experience quality evaluation model, or the feature data may be adjusted according to an actual analysis process, for example, one or more features may be reduced or added.

In an optional implementation, the predetermined feature data may be divided into three types of feature data as a whole, including audiovisual quality feature parameters in the cloud game session, interaction quality feature parameters in the cloud game session, and presentation quality parameters in the cloud game session.

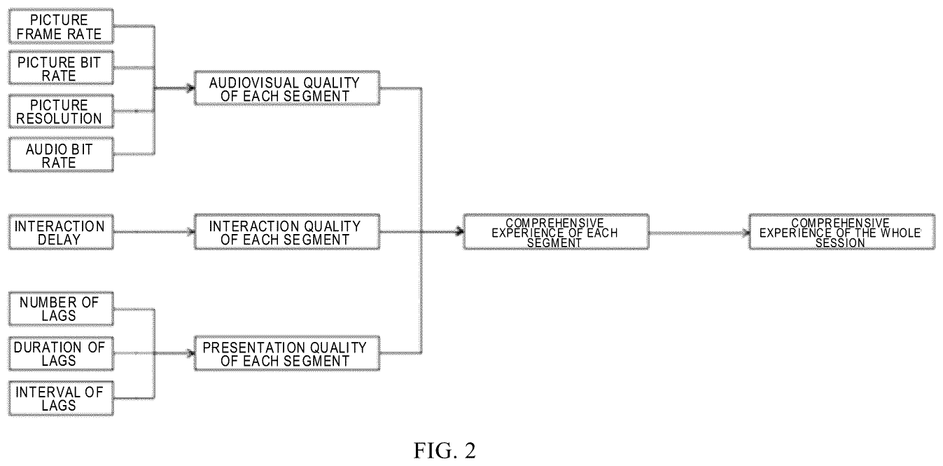

For example, as shown in the schematic diagram of the process of processing the predetermined feature data packets shown in FIG. 2, in the framework for the cloud game quality analysis of the embodiment, the audiovisual quality feature parameters may comprise parameters such as a picture frame rate, a picture bit rate, a picture resolution, and an audio bit rate of the cloud games; the interaction quality feature parameters may comprise a related parameter reflecting an interaction delay; and the presentation quality parameters may comprise parameters such as the number of times, durations, and intervals of the lags of the cloud game session. These parameters are parameters that can reflect the user experience quality of the cloud games under a generic experience quality evaluation framework.

At S120, the predetermined feature data corresponding to each of the historical cloud game sessions is grouped according to a predetermined segment duration, and a plurality of cloud game clip experience quality analysis results corresponding to each of the historical cloud game sessions are determined based on each group of the feature data.

In this step, unlike the MOS-QoE experience quality evaluation model in the prior art, overall feature analysis is performed on all predetermined feature data in the primary cloud game session to obtain a final analysis result. Instead, the predetermined feature data is grouped, each feature data group corresponds to one cloud game session clip, and the experience quality of the historical cloud game session is analyzed by using a segmented feature data analysis manner.

The reason why the experience quality of the historical cloud game session is analyzed by using the segmented feature data analysis manner is because certain parameter calculation schemes in the MOS-QoE experience quality evaluation model are discovered in the exploration of the MOS-QoE experience quality evaluation model, especially in terms of presentation quality and interaction quality. Specifically, in the calculation of the presentation quality parameters, the MOS-QoE experience quality evaluation model may score according to the number of times, durations and intervals of the lags occurring during the entire cloud game session, which may exaggerate the influence of a certain lag event on the entire cloud game session. However, according to the subjective feeling of the user and the principle of forgetting curves, the certain lag event only affects the user experience in a short time, and should not directly act on the entire cloud game session. The calculation of the interaction quality parameters also has a similar problem, and should not expand the influence of some delay information into the entire cloud game session, which would result in an inaccurate experience quality analysis result. Based on this, the MOS-QoE experience quality evaluation model is improved, and a cloud game user experience quality evaluation scheme based on segmentation calculation is provided, so that the influence of a single event influencing the duration of the cloud game session on the whole cloud game session is effectively avoided, and the actual experience of the user in the cloud game is more accurately reflected.

In an optional implementation, each of the historical cloud game sessions may be divided into a plurality of cloud game session clips according to a predetermined segment duration, and then, the predetermined feature data corresponding to each cloud game session clip of each of the historical cloud game sessions is divided into a group of predetermined feature data. For example, the predetermined segment duration is 20 s, a cloud game session with a session duration of ten minutes may be divided into 30 cloud game session clips, and the predetermined feature data in each cloud game session clip is divided into a group, that is, 30 groups of predetermined feature data may be divided. For each group of predetermined feature data, a calculation scheme of the MOS-QoE experience quality evaluation model is used to obtain a scoring result corresponding to each cloud game clip experience quality analysis result.

Further, in order to ensure a linear correlation between the cloud game experience quality analysis result and the session duration, the predetermined segment duration is set to be less than a predetermined session clip duration threshold, where the predetermined session clip duration threshold may be less than or equal to a duration threshold of 60 s. This is a result of exploring the cloud game experience quality analysis result and the average session duration relationship in the case of different segment durations. When the segment duration is 20 s, 30 s, etc., the scores of the cloud game experience quality analysis result and the average session duration exhibit significant positive correlation, and when the segment duration exceeds 60 s, a positive correlation phenomenon is weakened. This is because a short segment duration is more helpful in reducing the influence of lag events, delay fluctuation events and the like. In an actual application process, a final predetermined segment duration, for example, 10 s and 20 s, may be determined according to related factors such as operation capabilities and data amount of a cloud device.

At S130, corresponding target cloud game experience quality analysis results of each of the historical cloud game sessions are determined respectively based on the cloud game clip experience quality analysis results.

In this step, the cloud game clip experience quality analysis results determined in the foregoing step are integrated to obtain the target cloud game experience quality analysis results of each of the historical cloud game sessions. In an optional manner, an average or a weighted average of the cloud game clip experience quality analysis results may be used as the target cloud game experience quality analysis results, or a function relationship between the cloud game clip experience quality analysis results may be also predetermined, and a final target cloud game experience quality analysis result is determined based on the predetermined function relationship.

In an application example, by considering that game sessions of a plurality of cloud games of a plurality of predetermined cloud game providers are analytical objects of the experience quality, the cloud game experience quality analysis is performed based on the cloud game experience quality analysis method provided in the embodiment of the present disclosure. The predetermined segment duration may be set to 20 s, and a coordinate system of a relationship between scores of the target cloud game experience quality analysis results and an average cloud game session duration of the user may be established, where the horizontal axis is the scores of the target cloud game experience quality analysis results, and the vertical axis represents the average cloud game session duration at the corresponding score by column bars. Therefore, the functional relationship between the scores of the target cloud game experience quality analysis results and the average cloud game session duration of the user can be analyzed, and as the scores of the target cloud game experience quality analysis results are increased, the average cloud game duration of the user is obviously increased, which indicates that the scores of the target cloud game experience quality analysis results and the cloud game session duration are obviously a positive correlation under the segment duration of 20 s, that is, the higher the scores of the target cloud game experience quality analysis results are, the higher the user's desire to participate in the game continuously. Therefore, by analyzing the user experience quality of the cloud game according to the technical solution of the embodiment, an analysis result that can reflect the user's real experience more accurately can be obtained.

In the technical scheme of the embodiment of the present disclosure, the predetermined feature data associated with the cloud game experience quality during the historical cloud game sessions is obtained; the predetermined feature data corresponding to each of the historical cloud game sessions is grouped according to the predetermined segment duration, and the plurality of cloud game clip experience quality analysis results corresponding to each of the historical cloud game sessions are determined based on each group of the feature data; and the corresponding target cloud game experience quality analysis results of each of the historical cloud game sessions are determined respectively based on the cloud game clip experience quality analysis results. That is, after each historical cloud game session is segmented, the experience quality analysis is performed in units of cloud game session clips, so that the influence of the feature data influencing the experience quality in any cloud game session clip on the experience quality of other cloud game session clips is reduced, and the accuracy of a final target cloud game experience quality analysis result of each historical cloud game session is improved. According to the scheme of the embodiments of the present disclosure, the technical problem of poor application effect of the existing cloud game experience quality analysis model is solved, the actual experience of the user in the cloud game can be more accurately analyzed, accurate cloud game experience quality results are provided, so as to more efficiently guide a scheme for cloud game resource configuration and technical optimization.

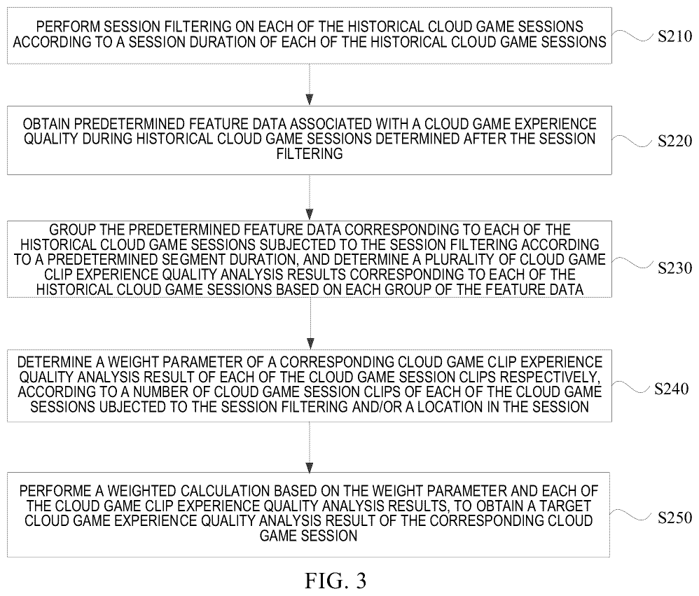

FIG. 3 is a schematic flowchart of yet another method for analyzing cloud game experience quality according to an embodiment of the present disclosure. On the basis of the above embodiments, in the process of implementing the method for analyzing cloud game experience quality, a process of filtering the cloud game sessions and determining weights of the cloud game clip experience quality analysis results is further explained and illustrated. The method may be performed by an apparatus for analyzing cloud game experience quality, which may be implemented in the form of software and/or hardware, and optionally, implemented by an electronic device, which may be a mobile terminal, a PC, a server, and the like.

As shown in FIG. 3, the method for analyzing cloud game experience quality comprises:
at S210, session filtering is performed on each of historical cloud game sessions according to a session duration of each of the historical cloud game sessions.

In order to avoid the influence of misoperations, test behaviors, or exceptional cloud game sessions on the cloud game experience quality analysis result in some relatively short session durations, in the embodiment, the cloud game sessions with relatively short session durations may be filtered out in advance. For example, a time threshold may be set to be 60 s, and then the cloud game sessions with the session durations of being shorter than 60 s are filtered out to increase the reliability of the final cloud game session experience quality analysis result.

At S220, predetermined feature data associated with a cloud game experience quality during historical cloud game sessions determined after the session filtering is obtained.

At S230, the predetermined feature data corresponding to each of the historical cloud game sessions subjected to the session filtering is grouped according to a predetermined segment duration, and a plurality of cloud game clip experience quality analysis results corresponding to each of the historical cloud game sessions subjected to the session filtering are determined based on each group of the feature data.

At S240, a weight parameter of a corresponding cloud game clip experience quality analysis result of each of the cloud game session clips is determined respectively according to a number of cloud game session clips of each of the cloud game sessions subjected to the session filtering and/or a location of each cloud game session clip in the session.

In an optional implementation, each cloud game session clip in each cloud game session may be used as a clip having the same influence on the target cloud game experience quality analysis results. Then, the same weight parameter may be set for the cloud game clip experience quality analysis result of each cloud game session clip according to the number of cloud game session clips in each cloud game session. For example, one cloud game session is divided into 50 cloud game session clips. Then, the weight parameter of the cloud game clip experience quality analysis result of each cloud game session clip may be set to a same value of 0.02 (divided by 1 by 50).

In yet another optional implementation, each cloud game session clip in each cloud game session may have different influences on the target cloud game experience quality analysis results. Correspondingly, the weight parameters of the cloud game clip experience quality analysis results of each cloud game session clip are different. Exemplarily, the weight parameter of the corresponding cloud game clip experience quality analysis result of each cloud game session clip may be determined according to the location of the cloud game session clip of the historical cloud game sessions subjected to the session filtering in the corresponding cloud game session. For example, a linear incremental manner may be used, so that a value of the weight parameter corresponding to the cloud game session clip earlier in the time sequence is lower, and a value of the weight parameter corresponding to the cloud game session clip later in the time sequence is lower. A non-linear weight setting may also be used, for example, an exponential function, to determine different weight parameters corresponding to different cloud game session clips.

Alternatively, in an implementation, the weight parameter settings corresponding to the cloud game session clips may be set in a segmented random averaging manner. For example, each cloud game session clip is grouped again, every 10 consecutive cloud game session clips randomly correspond to the same weight parameter, weight parameters corresponding to different groups of cloud game session clips are different, and a sum of the weight parameters corresponding to each cloud game session clip is 1.

At S250, a weighted calculation is performed based on the weight parameter and each of the cloud game clip experience quality analysis results, to obtain target cloud game experience quality analysis results of the corresponding cloud game session.

In the technical scheme of the embodiment of the present disclosure, the historical cloud game sessions are filtered before the cloud game user experience quality analysis is carried out, and the reliability of the cloud game experience quality analysis results can be further improved. After the cloud game sessions are filtered, the predetermined feature data associated with the cloud game experience quality during the historical cloud game sessions subjected to the session filtering is obtained; the predetermined feature data corresponding to each of the historical cloud game sessions subjected to the session filtering is grouped according to the predetermined segment duration, and the plurality of cloud game clip experience quality analysis results corresponding to each of the historical cloud game sessions subjected to the session filtering are determined based on each group of the feature data; and the corresponding target cloud game experience quality analysis results of each of the historical cloud game sessions subjected to the session filtering are determined based on the cloud game clip experience quality analysis results. That is, after each historical cloud game session subjected to the session filtering is segmented, the experience quality analysis is performed in units of cloud game session clips, so that the influence of the feature data influencing the experience quality in any cloud game session clip on the experience quality of other cloud game session clips is reduced, and the accuracy of a final target cloud game experience quality analysis result of each historical cloud game session is improved. According to the scheme of the embodiments of the present disclosure, the technical problem of poor application effect of the existing cloud game experience quality analysis model is solved, the actual experience of the user in the cloud game can be more accurately analyzed, accurate cloud game experience quality results are provided, so as to more efficiently guide a scheme for cloud game resource configuration and technical optimization.

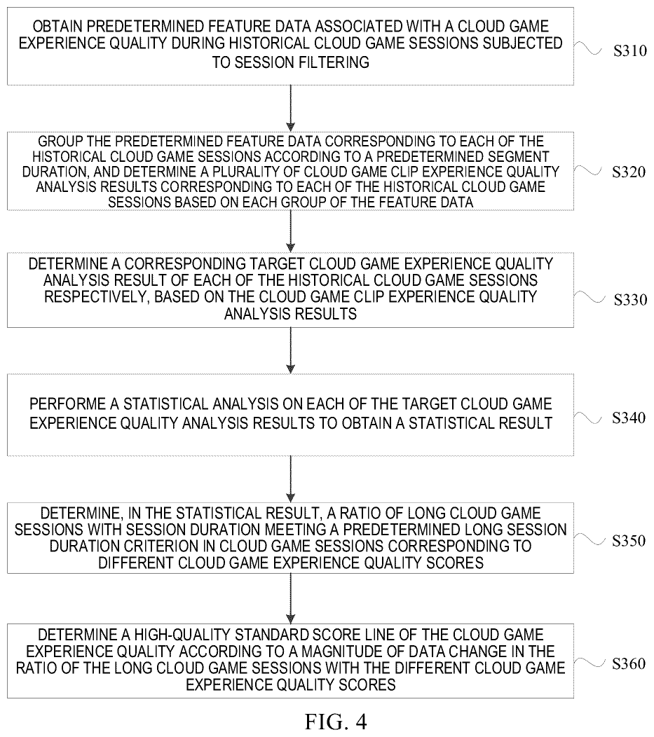

FIG. 4 is a schematic flowchart of yet another method for analyzing cloud game experience quality according to an embodiment of the present disclosure. On the basis of the above embodiments, a process of statistically analyzing the target cloud game experience quality analysis results and obtaining a reference standard for the cloud game experience quality analysis based on the statistical results is further explained and illustrated. The method may be performed by a cloud game experience quality analysis apparatus, which may be implemented in the form of software and/or hardware, and optionally, implemented by an electronic device, which may be a mobile terminal, a PC, a server, and the like.

As shown in FIG. 4, the cloud game experience quality analysis method comprises:
at S310, predetermined feature data associated with a cloud game experience quality during historical cloud game sessions subjected to session filtering is obtained.

At S320, the predetermined feature data corresponding to each of the historical cloud game sessions is grouped according to a predetermined segment duration, and a plurality of cloud game clip experience quality analysis results corresponding to each of the historical cloud game sessions are determined based on each group of the feature data.

At S330, corresponding target cloud game experience quality analysis results of each of the historical cloud game sessions are determined respectively based on the cloud game clip experience quality analysis results.

S340, a statistical analysis is performed on the target cloud game experience quality analysis results to obtain a statistical result.

In the embodiment, the cloud game experience quality is further evaluated and analyzed based on the target cloud game experience quality analysis results obtained by analyzing. A cloud game session classification analysis may be performed on a scoring value of each target cloud game experience quality analysis result, to further determine the influence of the cloud game experience quality on game durations of a user group.

In an optional embodiment, different cloud game session duration distribution features corresponding to scoring values of the target cloud game experience quality analysis results may be explored. For example, the cloud game session may be classified into three types: a short session (60 s≤duration<150 s), a medium session (150 s≤duration<1950s), and a long session (1950s≤duration) according to the average cloud game session duration of the user, so as to respectively count ratios of different types of cloud game sessions.

It can be understood that the short session means that the user exits the game in two or three minutes, and these users are very likely to quickly exit the game due to too poor network; the middle session means that the network status is good, and in the case of occasional lags, the user can also endure to play; and the long session means that the network status is excellent, and the subjective factor of the user exiting the game is large.

At S350, a ratio of long cloud game sessions with session duration meeting a predetermined long session duration criterion in cloud game sessions corresponding to different cloud game experience quality scores in the statistical result is determined.

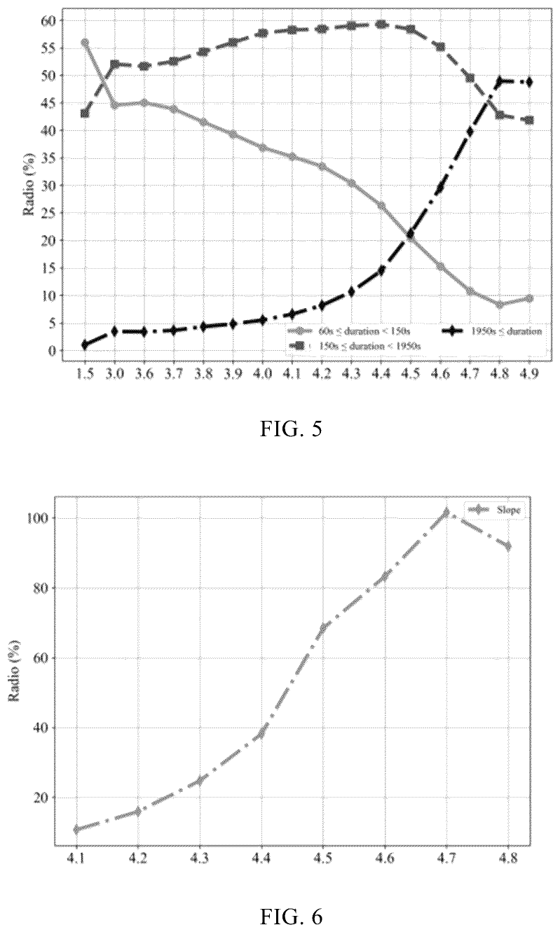

After the cloud game session classification analysis is performed, a distribution result shown in FIG. 5 may be obtained, the numbers of the horizontal axis represent the scoring values of the target cloud game experience quality analysis results, and the mark points represent the number of people in a certain session duration interval at the scoring value.

As can be seen from FIG. 5, the higher the scores of the target cloud game experience quality analysis results are, the higher the ratio of the long sessions is. In other words, as the scores of the target cloud game experience quality analysis results are increased, the ratio of the long sessions is increased from 0.99% to 48.76%, which is a reason why the average game duration is longer under the target cloud game experience quality analysis results. At the same time, this result also matches an assumption that the “game duration can effectively represent the user's game experience”, and any user will tend to play for a longer period of time only if the experience is good, that is, a longer game session is maintained.

At S360, a high-quality standard score line of the cloud game experience quality is determined according to a magnitude of data change in the ratio of the long cloud game sessions with the different cloud game experience quality scores.

The high-quality standard score line may be understood as that under the current score, the network condition is no longer a main reason why the user ends the game session and exits the game, and in a case that the experience quality is better, most users usually tend to keep a longer duration of the cloud game session.

It is determined that a threshold of the high-quality standard score line should meet a condition, that is, the speed at which the number of long sessions increases in the segment is the fastest, which reflects a maximum slope on the image. This indicates that the curve shown in FIG. 6 is a slope of changes in the number of long sessions corresponding to the target cloud game experience quality analysis results, and the high-quality standard score line of the target cloud game experience quality analysis results according to the foregoing condition should be set to a score of 4.7.

The setting of the high-quality standard score line may help the cloud game providers adjust the most efficient configuration for the cloud game. For example, a relationship between code rates, frame rates, and the target cloud game experience quality analysis results of the cloud game sessions can be explored, and the most cost-effective configuration is set, so that bandwidth and computing resources can be saved on the premise of not damaging the user experience, and the costs are reduced and the efficiency is improved.

In addition, it may be further determined that a ratio of short cloud game sessions with session duration meeting a predetermined short session duration criterion in the cloud game session corresponding to different cloud game experience quality scores in the statistical result is determined; and according to a magnitude of data change in the ratio of the short cloud game sessions with the different cloud game experience quality scores, a cloud game session random exit ratio corresponding to a cloud game is determined.

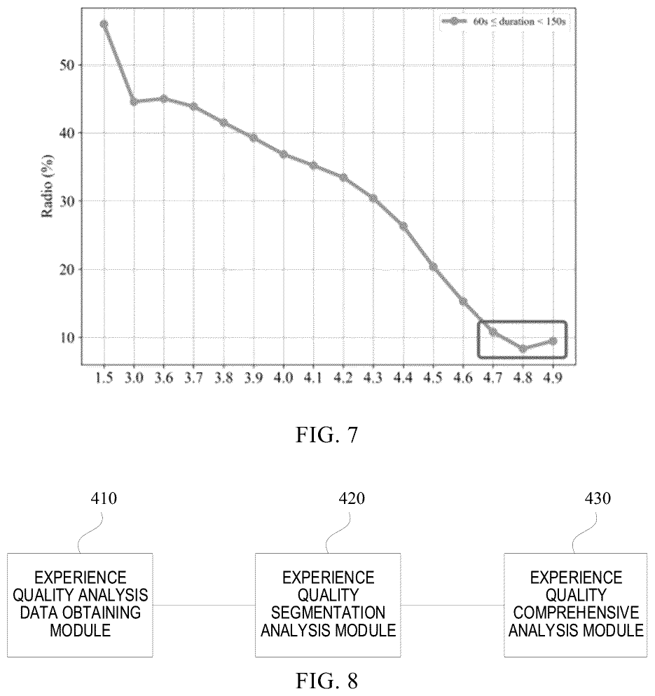

As can be seen from FIG. 7, when the score of the target cloud game experience quality analysis result reaches the high-quality standard score line and above, a change in the ratio of the user short sessions (<150 s) gradually tends to be stable, which indicates that there are always some users exiting the game due to other reasons besides network fluctuation. For example, some primary players will be likely to quit after playing a new game for a few minutes when they do not like it, and the ratio of these users may be referred to as a user random exit ratio, and an average ratio of the short sessions (<150 s) in which the target cloud game experience quality analysis result reaches the high-quality standard score line and above is set as the user random exit ratio. According to the above conditions, it can be calculated that the user random exit ratio is 9.51%.

The cloud capability of each cloud game provider can be tested by using the target cloud game experience quality analysis results, so that a large amount of manual comparison tests are omitted, and the setting of the user random exit ratio can also help calibrate whether the data provided by each cloud game provider is different or not.

In the technical scheme of the embodiment of the present disclosure, the predetermined feature data associated with the cloud game experience quality during the historical cloud game sessions subjected to short duration session filtering is obtained; the predetermined feature data corresponding to each of the historical cloud game sessions is grouped according to the predetermined segment duration, and the plurality of cloud game clip experience quality analysis results corresponding to each of the historical cloud game sessions are determined based on each group of the feature data; and the corresponding target cloud game experience quality analysis results of each of the historical cloud game sessions are determined respectively based on the cloud game clip experience quality analysis results. That is, after each historical cloud game session is segmented, the experience quality analysis is performed in units of cloud game session clips, so that the influence of the feature data influencing the experience quality in any cloud game session clip on the experience quality of other cloud game session clips is reduced, and the accuracy of the final target cloud game experience quality analysis result of each historical cloud game session is improved. Moreover, a statistical analysis is further performed on the target cloud game experience quality analysis results, a reference is provided for subsequent update and optimization of cloud game configurations, and significant guiding information is provided for subsequent cloud game optimization. According to the scheme of the embodiments of the present disclosure, the technical problem of poor application effect of the existing cloud game experience quality analysis model is solved, the actual experience of the user in the cloud game can be more accurately analyzed, accurate cloud game experience quality results are provided, so as to more efficiently guide a scheme for cloud game resource configuration and technical optimization.

FIG. 8 is an apparatus for analyzing cloud game experience quality according to an embodiment of the present disclosure, which is applicable to a scenario of experience quality evaluation of cloud game users, and the cloud game experience quality analysis apparatus may be implemented in the form of software and/or hardware, and may be configured on an electronic device, which may be a mobile terminal, a PC, a server, and the like.

As shown in FIG. 8, the apparatus for analyzing cloud game experience quality comprises an experience quality analysis data obtaining module 410, an experience quality segmentation analysis module 420, and an experience quality comprehensive analysis module 430.

The experience quality analysis data obtaining module 410 is configured to obtain predetermined feature data associated with a cloud game experience quality during historical cloud game sessions. The experience quality segmentation analysis module 420 is configured to group the predetermined feature data corresponding to each of the historical cloud game sessions according to a predetermined segment duration, and determine a plurality of cloud game clip experience quality analysis results corresponding to each of the historical cloud game sessions based on each group of the feature data. The experience quality comprehensive analysis module 430 is configured to determine corresponding target cloud game experience quality analysis results of each of the historical cloud game sessions, respectively, based on the cloud game clip experience quality analysis results, respectively.

In the technical scheme of the embodiment of the present disclosure, the predetermined feature data associated with the cloud game experience quality during the historical cloud game sessions is obtained; the predetermined feature data corresponding to each of the historical cloud game sessions is grouped according to the predetermined segment duration, and the plurality of cloud game clip experience quality analysis results corresponding to each of the historical cloud game sessions are determined based on each group of the feature data; and the corresponding target cloud game experience quality analysis results of each of the historical cloud game sessions are determined respectively based on the cloud game clip experience quality analysis results. That is, after each historical cloud game session is segmented, the experience quality analysis is performed in units of cloud game session clips, so that the influence of the feature data influencing the experience quality in any cloud game session clip on the experience quality of other cloud game session clips is reduced, and the accuracy of the final target cloud game experience quality analysis result of each historical cloud game session is improved. According to the scheme of the embodiments of the present disclosure, the technical problem of poor application effect of the existing cloud game experience quality analysis model is solved, the actual experience of the user in the cloud game can be more accurately analyzed, accurate cloud game experience quality results are provided, so as to more efficiently guide a scheme for cloud game resource configuration and technical optimization.

In an optional implementation, the cloud game experience quality analysis apparatus further comprises a session filtering module configured to:
before obtaining predetermined feature data associated with a cloud game experience quality during historical cloud game sessions, perform session filtering on each of the historical cloud game sessions according to a session duration of each of the historical cloud game sessions.

In an optional implementation, the experience quality segmentation analysis module 420 may be specifically configured to:
divide each of the historical cloud game sessions into a plurality of cloud game session clips according to a predetermined clip duration, where the predetermined segment duration is less than a predetermined session clip duration threshold; and
divide the corresponding predetermined feature data in each cloud game session clip of each of the historical cloud game sessions into a group of predetermined feature data.

In an optional implementation, the experience quality comprehensive analysis module 430 may be specifically configured to:
determine a weight parameter of a corresponding cloud game clip experience quality analysis result of each of the cloud game session clips, respectively, according to a number of cloud game session clips of each of the historical cloud game sessions and/or a location of each cloud game session clip in the session; and
perform a weighted calculation based on the weight parameter and each of the cloud game clip experience quality analysis results, to obtain target cloud game experience quality analysis results of the corresponding cloud game session.

In an optional implementation, the experience quality comprehensive analysis module 430 may be specifically configured to:
determine the same weight parameter for the cloud game clip experience quality analysis result of each cloud game session clip in each of the historical cloud game sessions, according to the number of cloud game session clips of each of the historical cloud game sessions.

In an optional implementation, the experience quality comprehensive analysis module 430 may be specifically configured to:
determine, according to a location of each cloud game clip in the corresponding cloud game session, a weight parameter of the cloud game clip experience quality analysis result corresponding to each of the cloud game session clips in a predetermined linear or non-linear weight parameter function.

In an optional implementation, the experience quality comprehensive analysis module 430 may be further specifically configured to:
perform a statistical analysis on each of the target cloud game experience quality analysis results to obtain a statistical result;
determine, in the statistical result, a ratio of long cloud game sessions with session duration meeting a predetermined long session duration criterion in cloud game sessions corresponding to different cloud game experience quality scores; and
determine a high-quality standard score line of the cloud game experience quality according to a magnitude of data change in the ratio of the long cloud game sessions with the different cloud game experience quality scores.

In an optional implementation, the experience quality comprehensive analysis module 430 may be further specifically configured to:
determine, in the statistical result, a ratio of short cloud game sessions with session duration meeting a predetermined short session duration criterion, in cloud game sessions corresponding to different cloud game experience quality scores; and
determine a cloud game session random exit ratio of a corresponding cloud game according to a magnitude of data change in the ratio of the short cloud game sessions with the different cloud game experience quality scores.

The cloud game experience quality analysis apparatus provided by the embodiments of the present disclosure may perform the cloud game experience quality analysis method provided by any of the embodiments of the present disclosure, and has functional modules and beneficial effects corresponding to the execution method.

It should be noted that the units and modules included in the foregoing apparatus are only divided according to a function logic, but are not limited to the foregoing division, as long as the corresponding functions can be implemented. In addition, the specific names of functional units are merely for easily distinguishing from each other, and are not intended to limit the protection scope of the embodiments of the present disclosure.

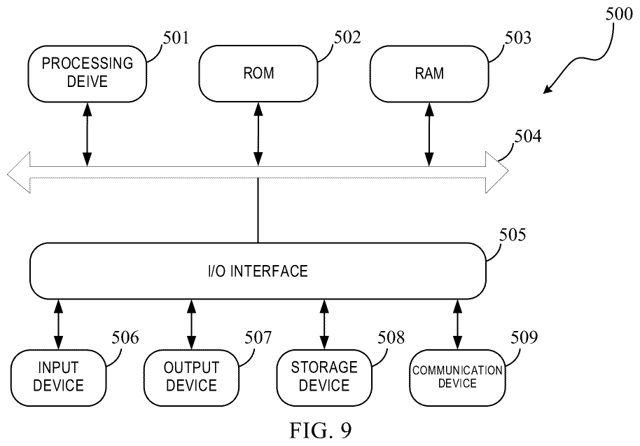

FIG. 9 is a schematic diagram of a structure of an electronic device according to an embodiment of the present disclosure. Reference is made to FIG. 9 below, which illustrates a schematic diagram of a structure of an electronic device (such as a terminal device or server in FIG. 9) 500 suitable for implementing the embodiments of the present disclosure. The terminal device in the embodiments of the present disclosure may include, but is not limited to, a mobile terminal such as a mobile phone, a notebook computer, a digital broadcast receiver, a personal digital assistant (PDA), a portable android device (PAD), a portable multimedia player (PMP), an in-vehicle terminal (for example, an in-vehicle navigation terminal), or the like, and a fixed terminal such as a digital TV, a desktop computer, or the like. The electronic device shown in FIG. 9 is merely an example, and should not impose any limitation on the functions and scope of use of the embodiments of the present disclosure.

As shown in FIG. 9, the electronic device 500 may include a processing device (for example, a central processing unit, a graphics processor, etc.) 501, which may perform various appropriate actions and processing according to a program stored in a read-only memory (ROM) 502 or a program loaded into a random access memory (RAM) 503 from a storage apparatus 508. In the RAM 503, various programs and data required by the operations of the electronic device 500 are also stored. The processing device 501, the ROM 502, and the RAM 503 are connected to each other through a bus 504. An input/output (I/O) interface 505 is also connected to the bus 504.

Generally, the following apparatuses may be connected to the I/O interface 505: an input device 506 including, for example, a touch picture, a touchpad, a keyboard, a mouse, a camera, a microphone, an accelerometer, a gyroscope, etc.; an output device 507 including, for example, a liquid crystal display (LCD), a speaker, a vibrator, etc.; the storage apparatus 508 including, for example, a magnetic tape, a hard disk, etc.; and a communication device 509. The communication device 509 may allow the electronic device 500 to communicate wirelessly or wirely with other devices to exchange data. While FIG. 9 illustrates the electronic device 500 having various apparatuses, it should be understood that it is not necessary to implement or have all illustrated apparatuses. More or fewer apparatuses may alternatively be implemented or provided.

In particular, according to an embodiment of the present disclosure, the processes described above with reference to the flowcharts may be implemented as a computer software program. For example, the embodiment of the present disclosure include a computer program product comprising a computer program embodied on a non-transitory computer-readable medium, the computer program comprises program codes for performing the method shown in the flowcharts. In such embodiments, the computer program may be downloaded and installed from the network through the communication device 509, or installed from the storage apparatus 508, or from the ROM 502. When the computer program is executed by the processing device 501, the foregoing functions defined in the method of the embodiment of the present disclosure are performed.

The names of messages or information interacted between multiple apparatuses in the embodiment of the present disclosure are for illustrative purposes only and are not intended to limit the scope of such messages or information.

The electronic device provided by the embodiment of the present disclosure and the cloud game experience quality analysis method provided in the foregoing embodiments belong to the same inventive concept, technical details not described in detail in the embodiment may refer to the foregoing embodiments, and the embodiment has the same beneficial effects as the foregoing embodiments.

An embodiment of the present disclosure further provides a computer storage medium having stored thereon a computer program, that when executed by a processor, implements the cloud game experience quality analysis method provided in the foregoing embodiments.

It should be noted that the computer-readable medium described above in the present disclosure may be a computer-readable signal medium, a computer-readable storage medium, or any combination of the foregoing. The computer-readable storage medium may be, for example, but not limited to, an electrical, magnetic, optical, electromagnetic, infrared, or semiconductor system, apparatus, or device, or any combination of the foregoing. More specific examples of the computer-readable storage medium may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In the present disclosure, the computer-readable storage medium may be any tangible medium containing or storing a program that may be used by or in conjunction with an instruction execution system, apparatus, or device. In the present disclosure, the computer-readable signal medium may include a data signal propagated in a baseband or as part of a carrier, where computer-readable program codes are carried. Such propagated data signals may take a variety of forms including, but not limited to, electromagnetic signals, optical signals, or any suitable combination of the foregoing. The computer-readable signal medium may also be any computer-readable medium other than the computer-readable storage medium, and may send, propagate, or transmit a program for use by or in conjunction with an instruction execution system, apparatus, or device. The program codes embodied on the computer-readable medium may be transmitted with any suitable medium, including, but not limited to: wires, optical cables, radio frequency (RF), and the like, or any suitable combination of the foregoing. Thereof

In some implementations, a client and a server may communicate using any currently known or future developed network protocol, such as HTTP (HyperText Transfer Protocol), and may be interconnected with any form or medium of digital data communication (e.g., a communication network). Examples of communication networks include local area networks (“LANs”), wide area networks (“WANs”), internets (e.g., the Internet), and peer-to-peer networks (e.g., ad hoc peer-to-peer networks), as well as any currently known or future developed networks.

The computer-readable medium described above may be included in the electronic device, or may be separately present without being assembled into the electronic device.

The computer-readable medium carries one or more programs, that when executed by the electronic device, cause the electronic device to:
obtain predetermined feature data associated with a cloud game experience quality during historical cloud game sessions;
group the predetermined feature data corresponding to each of the historical cloud game sessions according to a predetermined segment duration, and determine a plurality of cloud game clip experience quality analysis results corresponding to each of the historical cloud game sessions based on each group of the feature data; and
determine a corresponding target cloud game experience quality analysis result of each of the historical cloud game sessions respectively, based on the cloud game clip experience quality analysis results.

The computer program codes for performing the operations of the present disclosure may be written in one or more programming languages, including, but not limited to, object-oriented programming languages such as Java, Smalltalk, C++, and conventional procedural programming languages, such as the “C” language or similar programming languages. The program codes may be executed entirely on a user computer, partially on the user computer, as a stand-alone software package, partially on the user computer and partially on a remote computer, or entirely on the remote computer or server. In the case of a remote computer, the remote computer may be connected to the user computer through any type of networks, including a local area network (LAN) or a wide area network (WAN), or may be connected to an external computer (e.g., connected through the Internet using an Internet service provider).

The flowcharts and block diagrams in the drawings illustrate architectures, functionalities, and operations of possible implementations of systems, methods, and computer program products according to various embodiments of the present disclosure. In this regard, each block in the flowcharts or block diagrams may represent a module, program clip, or portion of code that includes one or more executable instructions for implementing the specified logical function. It should also be noted that in some alternative implementations, the functions noted in the blocks may also occur in a different order than that illustrated in the drawings. For example, two blocks shown in succession may in fact be executed substantially concurrently or the blocks may sometimes be executed in the reverse order, according to the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. Herein, the names of the units in some cases do not constitute a limitation on the units themselves. For example, the first obtaining unit may be further described as “a unit obtaining at least two Internet Protocol addresses”.

The functions described above may be performed, at least in part, by one or more hardware logic components. For example, without limitation, exemplary types of hardware logic components that may be used include: a field programmable gate array (FPGA), an application specific integrated circuit (ASIC), an application specific standard product (ASSP), a system-on-chip (SOC), a complex programmable logic device (CPLD), and the like.

In the context of the present disclosure, a machine-readable medium may be a tangible medium that may contain or store a program for use by or in conjunction with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination of the foregoing. More specific examples of the machine-readable storage medium may include electrical connections based on one or more wires, a portable computer disk, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

An embodiment of the present disclosure further provides a computer program product comprising a computer program, that when executed by a processor, implements the cloud game experience quality analysis method provided by any of the embodiments of the present disclosure.

The computer program product, during implementation, may write computer program codes for performing the operations of the present disclosure in one or more programming languages, or a combination of the foregoing, including an object-oriented programming language, such as Java, Smalltalk, C++, and conventional procedural programming languages, such as the “C” language or similar programming languages. The program codes may be executed entirely on a user computer, partially on the user computer, as a stand-alone software package, partially on the user computer and partially on a remote computer, or entirely on the remote computer or server. In the case of a remote computer, the remote computer may be connected to the user computer through any type of network, including a local area network (LAN) or a wide area network (WAN), or may be connected to an external computer (e.g., connected through the Internet using an Internet service provider).

According to one or more embodiments of the present disclosure, in example 1, there is provided a method for analyzing cloud game experience quality, comprising:
obtaining predetermined feature data associated with a cloud game experience quality during historical cloud game sessions;
grouping the predetermined feature data corresponding to each of the historical cloud game sessions according to a predetermined segment duration, and determining a plurality of cloud game clip experience quality analysis results corresponding to each of the historical cloud game sessions based on each group of the feature data; and
determining a corresponding target cloud game experience quality analysis result of each of the historical cloud game sessions respectively, based on the cloud game clip experience quality analysis results.

According to one or more embodiments of the present disclosure, in example 2, there is provided a method for analyzing cloud game experience quality, further comprising:
in some optional implementations, before obtaining the predetermined feature data associated with the cloud game experience quality during the historical cloud game sessions, performing session filtering on each of the historical cloud game sessions according to a session duration of each of the historical cloud game sessions.

According to one or more embodiments of the present disclosure, in example 3, there is provided a method for analyzing cloud game experience quality.

In some optional implementations, grouping the predetermined feature data corresponding to each of the historical cloud game sessions according to the predetermined segment duration comprises:
dividing each of the historical cloud game sessions into a plurality of cloud game session clips respectively according to the predetermined segment duration, wherein the predetermined clip duration is less than a predetermined session segments duration threshold; and
dividing the corresponding predetermined feature data in each cloud game session clip of each of the historical cloud game sessions into a group of predetermined feature data.

According to one or more embodiments of the present disclosure, in example 4, there is provided a method for analyzing cloud game experience quality.

In some optional implementations, determining the corresponding target cloud game experience quality analysis results of each of the historical cloud game sessions respectively, based on the cloud game clip experience quality analysis results comprises:
determining a weight parameter of a corresponding cloud game clip experience quality analysis result of each of the cloud game session clips respectively, according to a number of cloud game session clips of each of the historical cloud game sessions and/or a location of each cloud game session clips in the session; and
performing a weighted calculation based on the weight parameter and each of the cloud game clip experience quality analysis results, to obtain a target cloud game experience quality analysis result of the corresponding cloud game session.

According to one or more embodiments of the present disclosure, in example 5, there is provided a method for analyzing cloud game experience quality.

In some optional implementations, determining a weight parameter of a corresponding cloud game clip experience quality analysis result of each of the cloud game session clips respectively, according to a number of cloud game session clips of each of the historical cloud game sessions comprises:
determining the same weight parameter for the cloud game clip experience quality analysis result of each cloud game session clip in each of the historical cloud game sessions, according to the number of cloud game session clips of each of the historical cloud game sessions.

According to one or more embodiments of the present disclosure, in example 6, there is provided a method for analyzing cloud game experience quality, further comprising:
in some optional implementations, determining the weight parameter of a corresponding cloud game clip experience quality analysis result of each of the cloud game session clips respectively, according to the location of each cloud game session clips in the session comprises:
determining, according to the location of each cloud game clip in the corresponding cloud game session, a weight parameter of the cloud game clip experience quality analysis result corresponding to each of the cloud game session clips in a predetermined linear or non-linear weight parameter function.

According to one or more embodiments of the present disclosure, in example 7, there is provided a method for analyzing cloud game experience quality.

In some optional implementations, the method further comprises:
performing a statistical analysis on each of the target cloud game experience quality analysis results to obtain a statistical result;
determining, in the statistical result, a ratio of long cloud game sessions with session duration meeting a predetermined long session duration criterion in cloud game sessions corresponding to different cloud game experience quality scores; and
determining a high-quality standard score line of the cloud game experience quality according to a magnitude of data change in the ratio of the long cloud game sessions with the different cloud game experience quality scores.

According to one or more embodiments of the present disclosure, in example 8, there is provided a method for analyzing cloud game experience quality.

In some optional implementations, the method further comprises:
determining, in the statistical result, a ratio of short cloud game sessions with session duration meeting a predetermined short session duration criterion in cloud game sessions corresponding to different cloud game experience quality scores; and
determining a cloud game session random exit ratio of a corresponding cloud game according to a magnitude of data change in the ratio of the short cloud game sessions with the different cloud game experience quality scores.

According to one or more embodiments of the present disclosure, in example 9, there is provided an apparatus for analyzing cloud game experience quality, comprising:
an experience quality analysis data obtaining module configured to obtain predetermined feature data associated with a cloud game experience quality during historical cloud game sessions;
an experience quality segmentation analysis module configured to group the predetermined feature data corresponding to each of the historical cloud game sessions according to a predetermined segment duration, and determine a plurality of cloud game clip experience quality analysis results corresponding to each of the historical cloud game sessions based on each group of the feature data; and
an experience quality comprehensive analysis module configured to determine a corresponding target cloud game experience quality analysis result of each of the historical cloud game sessions respectively, based on the cloud game clip experience quality analysis results.

According to one or more embodiments of the present disclosure, in example 10, there is provided an apparatus for analyzing cloud game experience quality.

In an optional implementation, the cloud game experience quality analysis apparatus further comprises a session filtering module configured to:
before obtaining the predetermined feature data associated with the cloud game experience quality during the historical cloud game sessions, perform session filtering on each of the historical cloud game sessions according to a session duration of each of the historical cloud game sessions.

According to one or more embodiments of the present disclosure, in example 11, there is provided an apparatus for analyzing cloud game experience quality.

In an optional implementation, the experience quality segmentation analysis module may be specifically configured to:
divide each of the historical cloud game sessions into a plurality of cloud game session clips respectively according to the predetermined segment duration, wherein the predetermined segment duration is less than a predetermined session clips duration threshold; and
divide the corresponding predetermined feature data in each cloud game session clip of each of the historical cloud game sessions into a group of predetermined feature data.

According to one or more embodiments of the present disclosure, in example 12, there is provided an apparatus for analyzing cloud game experience quality.

In an optional implementation, the experience quality comprehensive analysis module may be specifically configured to:
determine a weight parameter of a corresponding cloud game clip experience quality analysis result of each of the cloud game session clips respectively, according to a number of cloud game session clips of each of the historical cloud game sessions and/or a location of each cloud game session clips in the session; and
perform a weighted calculation based on the weight parameter and each of the cloud game clip experience quality analysis results, to obtain a target cloud game experience quality analysis result of the corresponding cloud game session.

According to one or more embodiments of the present disclosure, in example 13, there is provided an apparatus for analyzing cloud game experience quality.

In an optional implementation, the experience quality comprehensive analysis module may be specifically configured to:
determine the same weight parameter for the cloud game clip experience quality analysis result of each cloud game session clip in each of the historical cloud game sessions, according to the number of cloud game session clips of each of the historical cloud game sessions.

According to one or more embodiments of the present disclosure, in example 14, there is provided an apparatus for analyzing cloud game experience quality.

In an optional implementation, the experience quality comprehensive analysis module 430 may be specifically configured to:
determine, according to the location of each cloud game clip in the corresponding cloud game session, a weight parameter of the cloud game clip experience quality analysis result corresponding to each of the cloud game session clips in a predetermined linear or non-linear weight parameter function.

According to one or more embodiments of the present disclosure, in example 15, there is provided an apparatus for analyzing cloud game experience quality.

In an optional implementation, the experience quality comprehensive analysis module may be further specifically configured to:
perform a statistical analysis on each of the target cloud game experience quality analysis results to obtain a statistical result;
determine, in the statistical result, a ratio of long cloud game sessions with session duration meeting a predetermined long session duration criterion in cloud game sessions corresponding to different cloud game experience quality scores; and
determine a high-quality standard score line of the cloud game experience quality according to a magnitude of data change in the ratio of the long cloud game sessions with the different cloud game experience quality scores.

According to one or more embodiments of the present disclosure, in example 16, there is provided an apparatus for analyzing cloud game experience quality.

In an optional implementation, the experience quality comprehensive analysis module may be further specifically configured to:
determine in the statistical result, a ratio of short cloud game sessions with session duration meeting a predetermined short session duration criterion in cloud game sessions corresponding to different cloud game experience quality scores; and
determining a cloud game session random exit ratio of a corresponding cloud game according to a magnitude of data change in the ratio of the short cloud game sessions with the different cloud game experience quality scores.

The above description is merely illustrative of the preferred embodiments of the present disclosure and of the technical principles applied thereto. As will be appreciated by those skilled in the art, the disclosure of the present disclosure is not limited to the technical solutions formed by the specific combination of the described technical features. Meanwhile, it should also cover other technical solutions formed by any combination of the described technical features or equivalent features thereof without departing from the described disclosed concept. For example, the above features and technical features having similar functions disclosed in the present disclosure (but not limited thereto) are replaced with each other to form a technical solution.

In addition, while operations are depicted in a particular order, this should not be understood as requiring the operations to be performed in the particular order shown or in sequential order. Multitasking and parallel processing may be advantageous in certain circumstances. Likewise, while several specific implementation details are included in the above discussion, these should not be construed as limiting the scope of the present disclosure. Certain features that are described in the context of separate embodiments can also be implemented in combination in a single embodiment. Conversely, various features that are described in the context of a single embodiment can also be implemented in multiple embodiments separately or in any suitable subcombination.

Although the subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

1. A method for analyzing cloud game experience quality, comprising:
obtaining predetermined feature data associated with a cloud game experience quality during historical cloud game sessions;
grouping the predetermined feature data corresponding to each of the historical cloud game sessions according to a predetermined segment duration, and determining a plurality of cloud game clip experience quality analysis results corresponding to each of the historical cloud game sessions based on each group of the feature data; and
determining a corresponding target cloud game experience quality analysis result of each of the historical cloud game sessions respectively, based on the cloud game clip experience quality analysis results.

2. The method of claim 1, wherein the method further comprises, before obtaining the predetermined feature data associated with the cloud game experience quality during the historical cloud game sessions:
performing session filtering on each of the historical cloud game sessions according to a session duration of each of the historical cloud game sessions.

3. The method of claim 1, wherein grouping the predetermined feature data corresponding to each of the historical cloud game sessions according to the predetermined segment duration comprises:
dividing each of the historical cloud game sessions into a plurality of cloud game session segments respectively according to the predetermined segment duration, wherein the predetermined segment duration is less than a predetermined session clips duration threshold; and
dividing the corresponding predetermined feature data in each cloud game session clip of each of the historical cloud game sessions into a group of predetermined feature data.

4. The method of claim 1, wherein determining the corresponding target cloud game experience quality analysis results of each of the historical cloud game sessions respectively, based on the cloud game clip experience quality analysis results comprises:
determining a weight parameter of a corresponding cloud game clip experience quality analysis result of each of the cloud game session clips respectively, according to a number of cloud game session clips of each of the historical cloud game sessions and/or a location of each cloud game session clips in the session; and
performing a weighted calculation based on the weight parameter and each of the cloud game clip experience quality analysis results, to obtain a target cloud game experience quality analysis result of the corresponding cloud game session.

5. The method of claim 4, wherein determining a weight parameter of a corresponding cloud game clip experience quality analysis result of each of the cloud game session clips respectively, according to a number of cloud game session clips of each of the historical cloud game sessions comprises:
determining the same weight parameter for the cloud game clip experience quality analysis result of each cloud game session clip in each of the historical cloud game sessions, according to the number of cloud game session clips of each of the historical cloud game sessions.

6. The method of claim 4, wherein determining the weight parameter of a corresponding cloud game clip experience quality analysis result of each of the cloud game session clips respectively, according to the location of each cloud game session clips in the session comprises:
determining, according to the location of each cloud game clip in the corresponding cloud game session, a weight parameter of the cloud game clip experience quality analysis result corresponding to each of the cloud game session clips in a predetermined linear or non-linear weight parameter function.

7. The method of claim 1, further comprising:
performing a statistical analysis on each of the target cloud game experience quality analysis results to obtain a statistical result;
determining, in the statistical result, a ratio of long cloud game sessions with session duration meeting a predetermined long session duration criterion in cloud game sessions corresponding to different cloud game experience quality scores; and
determining a high-quality standard score line of the cloud game experience quality according to a magnitude of data change in the ratio of the long cloud game sessions with the different cloud game experience quality scores.

8. The method of claim 7, further comprising:
determining, in the statistical result, a ratio of short cloud game sessions with session duration meeting a predetermined short session duration criterion in cloud game sessions corresponding to different cloud game experience quality scores; and
determining a cloud game session random exit ratio of a corresponding cloud game according to a magnitude of data change in the ratio of the short cloud game sessions with the different cloud game experience quality scores.

9. An electronic device, comprising:
one or more processors; and
a storage device for storing one or more programs,
wherein the one or more programs, when executed by the one or more processors, cause the one or more processors to implement the acts comprising:
obtaining predetermined feature data associated with a cloud game experience quality during historical cloud game sessions;
grouping the predetermined feature data corresponding to each of the historical cloud game sessions according to a predetermined segment duration, and determining a plurality of cloud game clip experience quality analysis results corresponding to each of the historical cloud game sessions based on each group of the feature data; and
determining a corresponding target cloud game experience quality analysis result of each of the historical cloud game sessions respectively, based on the cloud game clip experience quality analysis results.

10. The electronic device of claim 9, wherein the acts further comprises, before obtaining the predetermined feature data associated with the cloud game experience quality during the historical cloud game sessions:
performing session filtering on each of the historical cloud game sessions according to a session duration of each of the historical cloud game sessions.

11. The electronic device of claim 9, wherein grouping the predetermined feature data corresponding to each of the historical cloud game sessions according to the predetermined segment duration comprises:
dividing each of the historical cloud game sessions into a plurality of cloud game session segments respectively according to the predetermined segment duration, wherein the predetermined segment duration is less than a predetermined session clips duration threshold; and
dividing the corresponding predetermined feature data in each cloud game session clip of each of the historical cloud game sessions into a group of predetermined feature data.

12. The electronic device of claim 9, wherein determining the corresponding target cloud game experience quality analysis results of each of the historical cloud game sessions respectively, based on the cloud game clip experience quality analysis results comprises:
determining a weight parameter of a corresponding cloud game clip experience quality analysis result of each of the cloud game session clips respectively, according to a number of cloud game session clips of each of the historical cloud game sessions and/or a location of each cloud game session clips in the session; and
performing a weighted calculation based on the weight parameter and each of the cloud game clip experience quality analysis results, to obtain a target cloud game experience quality analysis result of the corresponding cloud game session.

13. The electronic device of claim 12, wherein determining a weight parameter of a corresponding cloud game clip experience quality analysis result of each of the cloud game session clips respectively, according to a number of cloud game session clips of each of the historical cloud game sessions comprises:
determining the same weight parameter for the cloud game clip experience quality analysis result of each cloud game session clip in each of the historical cloud game sessions, according to the number of cloud game session clips of each of the historical cloud game sessions.

14. The electronic device of claim 12, wherein determining the weight parameter of a corresponding cloud game clip experience quality analysis result of each of the cloud game session clips respectively, according to the location of each cloud game session clips in the session comprises:
determining, according to the location of each cloud game clip in the corresponding cloud game session, a weight parameter of the cloud game clip experience quality analysis result corresponding to each of the cloud game session clips in a predetermined linear or non-linear weight parameter function.

15. The electronic device of claim 9, wherein the acts further comprising:
performing a statistical analysis on each of the target cloud game experience quality analysis results to obtain a statistical result;
determining, in the statistical result, a ratio of long cloud game sessions with session duration meeting a predetermined long session duration criterion in cloud game sessions corresponding to different cloud game experience quality scores; and
determining a high-quality standard score line of the cloud game experience quality according to a magnitude of data change in the ratio of the long cloud game sessions with the different cloud game experience quality scores.

16. The electronic device of claim 15, wherein the acts further comprising:
determining, in the statistical result, a ratio of short cloud game sessions with session duration meeting a predetermined short session duration criterion in cloud game sessions corresponding to different cloud game experience quality scores; and
determining a cloud game session random exit ratio of a corresponding cloud game according to a magnitude of data change in the ratio of the short cloud game sessions with the different cloud game experience quality scores.

17. A non-transitory computer-readable storage medium having stored thereon a computer program which, when executed by a processor, implements the operations comprising:
obtaining predetermined feature data associated with a cloud game experience quality during historical cloud game sessions;
grouping the predetermined feature data corresponding to each of the historical cloud game sessions according to a predetermined segment duration, and determining a plurality of cloud game clip experience quality analysis results corresponding to each of the historical cloud game sessions based on each group of the feature data; and
determining a corresponding target cloud game experience quality analysis result of each of the historical cloud game sessions respectively, based on the cloud game clip experience quality analysis results.

18. The non-transitory computer-readable storage medium of claim 17, wherein the operations further comprise, before obtaining the predetermined feature data associated with the cloud game experience quality during the historical cloud game sessions:
performing session filtering on each of the historical cloud game sessions according to a session duration of each of the historical cloud game sessions.

19. The non-transitory computer-readable storage medium of claim 17, wherein grouping the predetermined feature data corresponding to each of the historical cloud game sessions according to the predetermined segment duration comprises:
dividing each of the historical cloud game sessions into a plurality of cloud game session segments respectively according to the predetermined segment duration, wherein the predetermined segment duration is less than a predetermined session clips duration threshold; and
dividing the corresponding predetermined feature data in each cloud game session clip of each of the historical cloud game sessions into a group of predetermined feature data.

20. The non-transitory computer-readable storage medium of claim 17, wherein determining the corresponding target cloud game experience quality analysis results of each of the historical cloud game sessions respectively, based on the cloud game clip experience quality analysis results comprises:
determining a weight parameter of a corresponding cloud game clip experience quality analysis result of each of the cloud game session clips respectively, according to a number of cloud game session clips of each of the historical cloud game sessions and/or a location of each cloud game session clips in the session; and
performing a weighted calculation based on the weight parameter and each of the cloud game clip experience quality analysis results, to obtain a target cloud game experience quality analysis result of the corresponding cloud game session.
